(19) United States
(12) Patent Application Publication
(10) Pub. No.: US 2006/0213061 A1
(43) Pub. Date: Sep. 28, 2006

(54) METHOD FOR MAKING A HEAT PIPE

(76) Inventors: Jung-Yuan Wu, Shenzhen (CN); Chu-Wan Hong, Shenzhen (CN); Ching-Tai Cheng, Shenzhen (CN); Chang-Ting Lo, Shenzhen (CN)

Correspondence Address: NORTH AMERICA INTELLECTUAL PROPERTY CORPORATION, P.O. BOX 506, MERRIFIELD, VA, 22116, US

(21) Appl. No.: 11/164,859

(22) Filed: Dec. 8, 2005

(30) Foreign Application Priority Data
Mar. 25, 2005 (TW) 094109327

(51) Int. Cl. B23P 6/00

(52) U.S. Cl. 29/890.032

(57) ABSTRACT

A method (50) for making a heat pipe (10) includes the following steps: a) providing a screen mesh (30) in the form of a multi-portion structure with at least one portion having an average pore size different from that of the other portions; b) rolling the screen mesh into a hollow column form; c) inserting the screen mesh into a hollow pipe body (22) of the heat pipe; d) sintering the screen mesh received therein at a predetermined temperature; and e) filling a working fluid into the pipe body and sealing the pipe body. The portion with large-sized pores is capable of reducing the flow resistance to a condensed fluid to flow back, whereas the portion with small-size pores is capable of providing a relatively large capillary pressure for drawing the condensed fluid from the condensing section to the evaporating section of the heat pipe.

### FIELD OF THE INVENTION

The present invention relates generally to a heat pipe as a heat transfer device, and more particularly to a method for making a heat pipe with a wick structure of screen mesh.

### DESCRIPTION OF RELATED ART

As electronic industry continues to advance, electronic components such as central processing units (CPUs), are made to provide faster operation speeds and greater functional capabilities. When a CPU operates at a high speed, its temperature frequently increases greatly. It is desirable to dissipate the heat generated by the CPU quickly.

To solve this problem of heat generated by the CPU, a cooling device is often used to be mounted on top of the CPU to dissipate heat generated thereby. It is well known that heat absorbed by fluid having a phase change is ten times more than that the fluid does not have a phase change; thus, the heat transfer efficiency by phase change of fluid is better than other mechanisms, such as heat conduction or heat convection. Thus a heat pipe has been developed.

The heat pipe has a hollow pipe body receiving a working fluid therein and a wick structure disposed on an inner wall of the pipe body. During operation of the heat pipe, the working fluid absorbs the heat generated by the CPU or other electronic device and evaporates. Then the vapor moves to the condensing section to release the heat thereof. The vapor cools and condenses at the condensing section. The condensed working fluid returns to the evaporating section and evaporates into vapor again, whereby the heat is continuously transferred from the evaporating section to the condensing section. Thus, the heat generated by the CPU can be effectively dissipated.

The movement of the condensed working fluid from the condensing section to the evaporating section depends on capillary pressure of the wick structure. Usually the wick structure has following four configurations: sintered powder, grooved, fiber and screen mesh. For the thickness and pore size of the screen mesh can be easily changed, the screen mesh is widely used in the heat pipe.

It is well recognized that the capillary pressure of a screen mesh increases due to a decrease in pore size of the screen mesh. In order to obtain a relatively larger capillary pressure for a screen mesh, a screen mesh having small-sized pores is usually adopted. However, it is not always the best way to choose a screen mesh having small-sized pores, because the flow resistance to the condensed working fluid also increases due to the decrease in pore size of the screen mesh. The increased flow resistance reduces the speed of the condensed working fluid in returning back to the evaporating section and therefore limits the heat transfer performance of the heat pipe. As a result, a heat pipe with a screen mesh that has too large or too small pore size often suffers dry-out problem at the evaporating section as the condensed working fluid cannot be timely sent back to the evaporating section of the heat pipe.

Therefore, there is a need for a heat pipe with a screen mesh which can provide simultaneously a relatively larger capillary pressure and a relatively lower flow resistance so as to effectively and timely bring condensed working fluid back from a condensing section to a evaporating section of a heat pipe and thereby to avoid the undesirable dry-out problem at the evaporating section.

### SUMMARY OF INVENTION

According to a preferred embodiment of the present invention, a method for making a heat pipe includes the following steps: a) providing a screen mesh in the form of a multi-portion structure with at least one portion thereof having an average pore size different from that of the other portions; b) rolling the screen mesh into column form; c) positioning the screen mesh into a pipe body of the heat pipe; d) sintering the screen mesh received in the pipe body at a predetermined temperature so that the screen mesh is bonded to an inner wall of the pipe body; e) filling a working fluid into the pipe body and sealing the pipe body. The portion with large-sized pores is capable of reducing the flow resistance to a condensed fluid to flow back, whereas the portion with small-size pores is capable of providing a relatively large capillary pressure for drawing the condensed fluid from the condensing section to the evaporating section of the heat pipe.

Other objects, advantages and novel features of the present invention will be drawn from the following detailed description of a preferred embodiment of the present invention with attached drawings, in which:

### BRIEF DESCRIPTION OF DRAWINGS

FIG. 1 is a longitudinal cross-sectional view of a heat pipe in accordance with the present invention;

FIG. 2 is a flow chart showing a preferred method of making the heat pipe of FIG. 1;

FIG. 3 is a plain view of a screen mesh under an expanded condition for making a wick structure of the heat pipe of FIG. 1;

FIG. 4 is a perspective view of the screen mesh of FIG. 3 rolled onto a mandrel along an end-to-end direction of the screen mesh;

FIG. 5 is a cross-sectional view, showing the rolled screen mesh and the mandrel received in a part of a hollow pipe body of the heat pipe;

FIG. 6 is similar to FIG. 4, but showing the screen mesh rolled onto the mandrel along a side-to-side direction of the screen mesh.

FIG. 7 shows a screen mesh made by stacking several meshes together;

FIG. 8 is similar to FIG. 7, but showing a second embodiment of the screen mesh;

FIG. 9 shows a third embodiment of the screen mesh made from the same method as shown in FIG. 7; and

FIG. 10 shows an alternative embodiment of the screen mesh.

### DETAILED DESCRIPTION

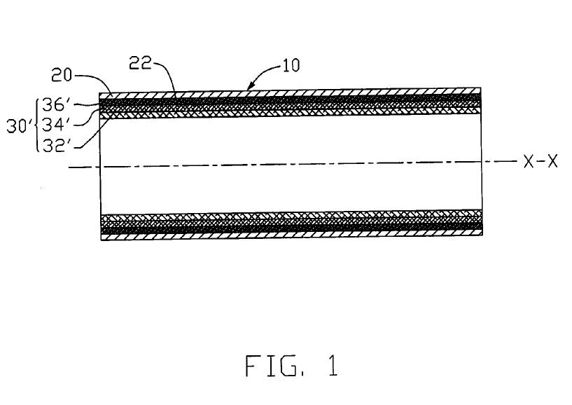

FIG. 1 illustrate a heat pipe 10 formed in accordance with a method of the present invention. The heat pipe 10 is vacuumed and includes a pipe body 20 and a wick structure 30′ of a screen mesh arranged against an inner wall 22 of the pipe body 20. The heat pipe 10 is divided into an evaporating section, an adiabatic section and a condensing section along an axial direction of the heat pipe 10. The adiabatic section is located between the evaporating and condensing sections.

The pipe body 20 is made of high thermally conductive material such as copper or aluminum. Although the pipe body 20 illustrated is in a round shape, it should be recognized that other shapes, such as polygon, rectangle, or triangle, may also be suitable. Although it is not shown in the drawings, it is well known by those skilled in the art that two ends of the pipe body 20 are sealed.

The wick structure 30′ is saturated with a working fluid (not shown), which acts as a heat carrier when undergoing phase transitions between liquid state and vaporous state. The wick structure 30′ is in the form of a multi-layer structure, which includes in sequence an inner layer 32′, a middle layer 34′ and an outer layer 36′. These layers 32′, 34′, 36′ are stacked together along a radial direction of the pipe body 20 with the outer layer 36′ abutting the inner wall 22 of the pipe body 20. Each layer of the wick structure 30′ has an average pore size different from that of the other layers, and these layers 32′, 34′, 36′ are stacked together in such a manner that the average pore sizes thereof gradually decrease along the radial direction from a central axis X-X of the pipe body 20 towards the inner wall 22 of the pipe body 20.

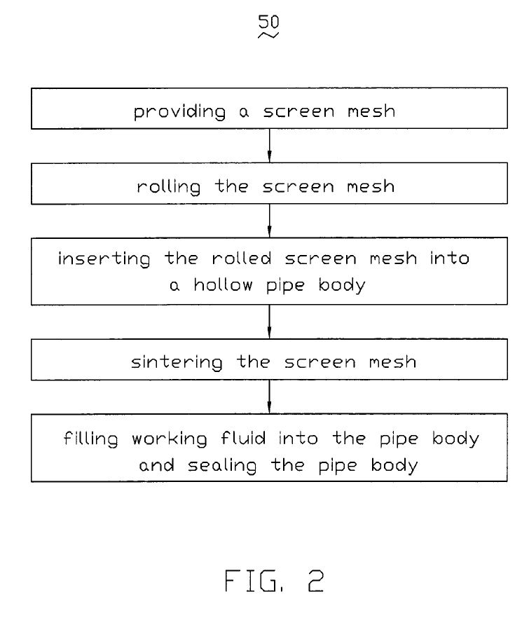

In the present invention, a method 50 as shown in FIG. 2 is proposed to construct the heat pipe 10. The method 50 includes a step providing a flat screen mesh 30.

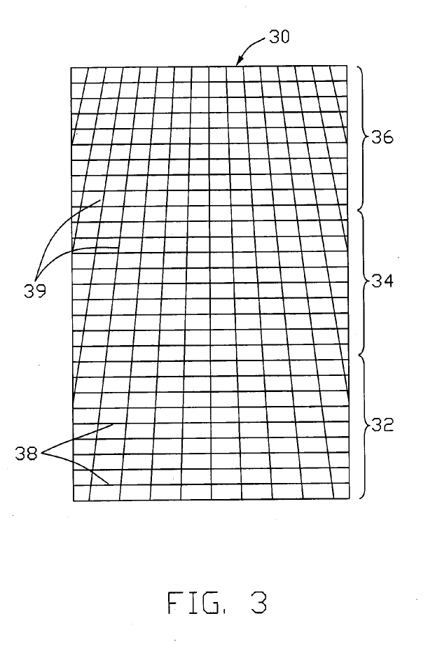

As shown in FIG. 3, the screen mesh 30 is rectangular-shaped and formed by weaving a plurality of first wires 38 (i.e., woof) and a plurality of second wires 39 (i.e., warp) together. The wires 38, 39 are made of stainless steel, copper etc., which can coexist with the working fluid. The first wires 38 extend along a lateral direction, whereas the second wires 39 extend along a longitudinal of the screen mesh 30. The distance between each two neighboring first wires 38 is constant. The distance between each two neighboring second wires 39 gradually decreases along the longitudinal direction of the screen mesh 30 from a bottom end to a top end thereof as viewed from FIG. 3. Along the longitudinal direction the screen mesh 30 can be generally divided into three portions, which includes in sequence, from the bottom end to the top end, a first portion 32, a second portion 34 and a third portion 36. Each portion of the screen mesh 30 has an average pore size different from that of the other portions. The first portion 32 has the largest average pore size, whereas the third portion 36 has the smallest average pore size. The screen mesh 30 has a length approximately the same as that of the pipe body 20. Furthermore, the screen mesh 30 has a width approximately the same as a circumference of the inner wall 22 of the pipe body 20; accordingly, the screen mesh 30 can fully cover the inner wall 22 of the pipe body 20.

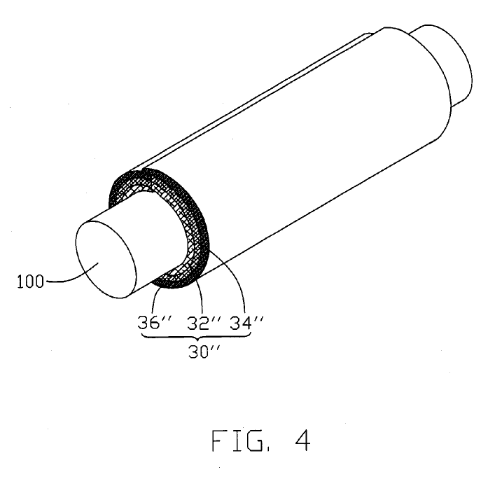

As shown in FIG. 4, the screen mesh 30 is then rolled onto an outer surface of a mandrel 100 along an end-to-end direction of the screen mesh 30. The mandrel 100 may be a solid column made of stainless steel material. The shape of the mandrel 100 may vary according to the shapes or structures of the heat pipe 10 to be formed. In this embodiment, the mandrel 100 is column-shaped and thus the furled screen mesh 30″ has a shape of a hollow column. The three portions 32, 34, 36 of the screen mesh 30 are rolled to a three-layer form along a radial direction of the mandrel 100, which in sequence includes an inner layer 32″, a middle layer 34″, and an outer layer 36″. The first portion 32 of the screen mesh 30 forms the inner layer 32″ of the furled screen mesh 30″ and abuts to the outer surface of the mandrel 100 directly, whereas the third portion 36 of the screen mesh 30 forms the outer layer 36″ of the furled screen mesh 30″.

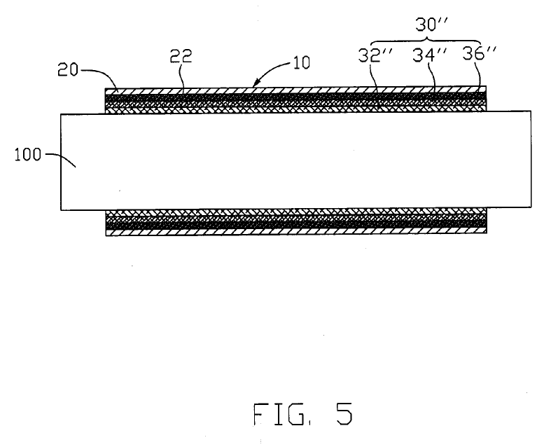

Then, the mandrel 100, together with the furled screen mesh 30″ thereon is inserted into the hollow pipe body 20, as shown in FIG. 5. The outer layer 36″ of the furled screen mesh 30″ is held against the inner wall 22 of the pipe body 20 by the mandrel 100. The inner layer 32″ of the furled screen mesh 30″ abuts the outer surface of the mandrel 100. The pipe body 20 and the furled screen mesh 30″ received therein are then heated under a predetermined temperature to thereby sinter the furled screen mesh 30″ to make the furled screen mesh 30″ and the pipe body 20 bonded together. Thus, the inner, middle, and outer layers 32′, 34′, 36′ of the wick structure 30′ of the heat pipe 10 of FIG. 1 are constructed from the first, second, and third portions 32, 34, 36 of the screen mesh 30, respectively. That is, the three layers 32′, 34′, 36′ of the wick structure 30′ are arranged in such a manner that the average pore sizes thereof gradually increase along the radial direction from the inner wall 22 of the pipe body 20 towards a central axis X-X of the pipe body 20 of FIG. 1.

After this, the mandrel 100 is drawn out of the pipe body 20. Finally, the pipe body 20 is vacuumed and a working fluid such as water, alcohol, methanol, or the like, is injected into the pipe body 20, and then the pipe body 20 is hermetically sealed to form the heat pipe 10.

The inner layer 32′ and the middle layer 34′ of the wick structure 30′ of the heat pipe 10 have a relatively larger average pore size and therefore are capable of providing a relatively low resistance to the condensed working fluid to flow back. The outer layer 36′, however, has a relatively smaller average pore size and therefore is capable of having a relatively high capillary pressure for drawing the condensed working fluid back to the evaporating section. Thus, the three-layer construction of the wick structure 30′ is capable of providing between these layers, along the radial direction of the pipe body 20, a gradient of capillary pressure gradually increasing from the central axis X-X of the pipe body 20 toward the inner wall 22 of the pipe body 20, and a gradient of flow resistance gradually decreasing from the inner wall 22 of the pipe body 20 toward a central axis X-X of the pipe body 20. Furthermore, the outer layer 36′ with small-sized pores is also capable of maintaining an increased contact surface area with the inner wall 22 of the pipe body 20, as well as a large contact surface with the working fluid saturated in the wick structure 30′, to thereby facilitate heat transfer between the working fluid in the heat pipe 10 and a heat source outside the heat pipe 10 that needs to be cooled.

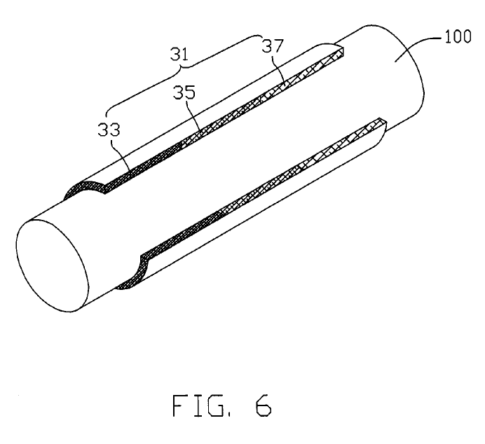

As shown in FIG. 6, the method as shown above is also capable of producing a heat pipe with a multi-section wick structure along an axial direction thereof. In this embodiment, the screen mesh 30 is rolled onto the mandrel 100 along a side-to-side direction of the screen mesh 30. Thus the three portions of the screen mesh 30 from three sections of a wick structure 31 along an axis direction of the mandrel 100, which include in sequence a first section 33, a second section 35 and a third section 37. Finally the three sections 33, 35, 37 construct the wick structure 31 in the form of three sections along an axial of the pipe body 20. The three sections 33, 35, 37 of the wick structure 31 correspond to the evaporating section, adiabatic section and condensing section of the heat pipe 10, respectively. Accordingly, this three-section construction of wick structure 31 is capable of providing a capillary pressure gradually increasing from the condensing section toward the evaporating section, and a flow resistance gradually decreasing from the evaporating section toward the condensing section.

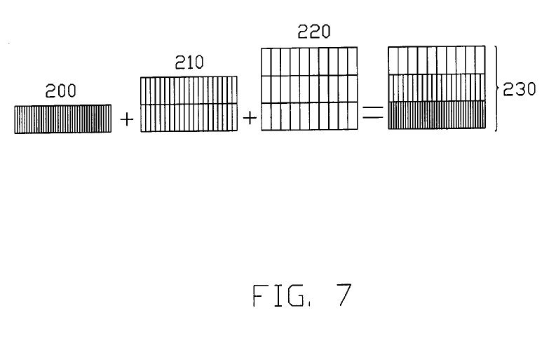

FIG. 7 shows another method for forming a screen mesh for use in the present invention. In this method, a screen mesh 230 is formed by stacking three meshes 200, 210, 220 together. The three meshes 200, 210, 220 have average pore sizes different from each other, in which the mesh 200 has the smallest pore size while the mesh 220 has the largest pore size. The three meshes 200, 210, 220 have the same width and different lengths, wherein the mesh 220 is the longest and the mesh 200 is the shortest. The length of the mesh 200 is half of that of the mesh 210, and one-third of that the mesh 220. Thus these three meshes form the screen mesh 230 having an average pore size gradually increasing along a longitudinal direction thereof. When the screen mesh 230 is rolled side-by-side and mounted in the pipe body 20 of the heat pipe 10 of FIG. 1, a wick structure having a varied capillary force and flow resistance along a length of the heat pipe 10 can be obtained by the screen mesh 230.

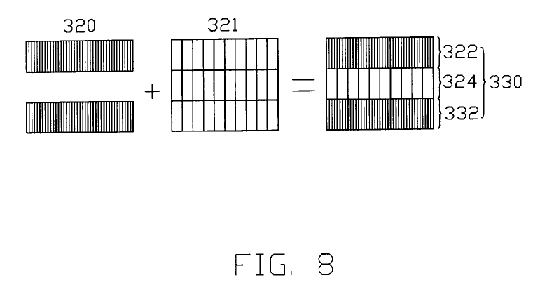

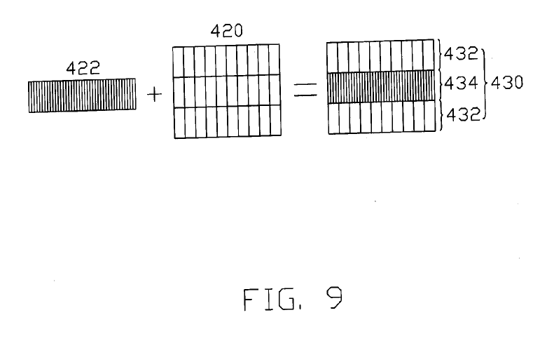

Referring to FIGS. 8-9, the method shown in FIG. 7 is also capable of producing a screen mesh in other structure. As shown in FIG. 8, a screen mesh 330 is constructed from stacking a first mesh 321 having a relatively larger average pore size, and a pair of second meshes 320 having a relatively smaller average pore size together. The length of the first mesh 321 is three times as that of the second mesh 320. The second meshes 320 are arranged to overlap opposite upper and lower end portions of the first mesh 321, respectively. Thus, the screen mesh 330 is in the form of three-portion, in which the upper and lower end portions 332 each have an average pore size smaller than that of a middle portion 334 located between the two end portions 332. FIG. 9 shows another form of a screen mesh for use in the present invention. A screen mesh 430 is constructed from a first mesh 420 having a relatively larger average pore size, and a second mesh 422 having a relatively smaller average pore size. The length of the first mesh 420 is three times of that of the second mesh 422. The second mesh 422 is arranged to overlap a middle portion of the first mesh 40. Thus the screen mesh 430 is in the form of three-portion, in which the two outer portions 432 have an average pore size larger than that of the middle portion 434 located between the two outer portions 432.

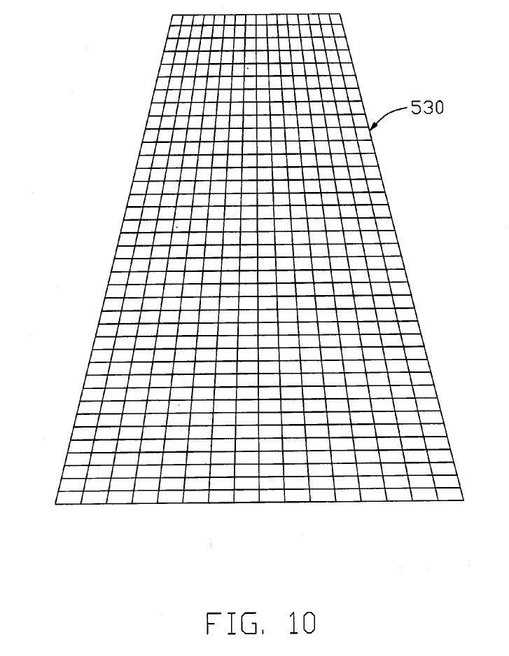

Each screen mesh as shown above has a rectangular shape; thus the thickness of the wick structure constructed by these screen meshes, when they are rolled side-by-side, is even. It is understood that the screen mesh can be in other form, such as trapezoid, as shown in FIG. 10. The pore size of the screen mesh 530 gradually decreases along a longitudinal direction thereof. Furthermore, the thickness of the wick structure constructed by the screen mesh 530 is not even when the screen mesh 530 is rolled to a mandrel 100 along a side-by-side direction of the screen mesh 530. The wick structure formed by a lower end portion of the screen mesh 530 as viewed from FIG. 10 has a larger thickness.

It is understood that the invention may be embodied in other forms without departing from the spirit thereof. Thus, the present example and embodiment is to be considered in all respects as illustrative and not restrictive, and the invention is not to be limited to the details given herein.

What is claimed is:

1. A method for making a heat pipe comprising the following steps:
providing a screen mesh, the screen mesh comprising several portions, at least one portion of the several portions having an average pore size different from that of the other portions;
rolling the screen mesh into a hollow column form; and
positioning the rolled screen mesh into a pipe body of the heat pipe.

2. The method of claim 1, wherein each portion of the several portions has an average pore size different from that of a neighboring portion thereof.

3. The method of claim 1, wherein the hollow column-shaped screen mesh comprises several layers corresponding to the several portions of the screen portion.

4. The method of claim 3, wherein the screen mesh comprises a plurality of first wires extending along a lateral direction and a plurality of second wires extending along a longitudinal direction thereof, a distance between each two neighboring first wires is constant, a distance between each two neighboring second wires is varied.

5. The method of claim 4, wherein the screen mesh is rolled along an end-to-end direction of the screen mesh, and constructs the several layers along a radial direction of the hollow column-shaped screen mesh.

6. The method of claim 1, wherein the screen mesh is rolled along a side-to-side direction of the screen mesh, and constructs several sections along an axial direction of the hollow column-shaped screen mesh, the sections having different average pore sizes.

7. The method of claim 4, wherein the screen mesh is made by weaving the first wires and the second wires together.

8. The method of claim 4, wherein the screen mesh is constructed from stacking several meshes together, at least one of the meshes having an average pore size and dimension different from those of the other meshes.

9. The method of claim 8, wherein the meshes comprises a mesh having a relatively larger area and average pore size, and a mesh having a relatively smaller area and average pore size.

10. The method of claim 4, wherein the distance between each two neighboring second wires gradually decreases along the extending direction of the second wires.

11. The method of claim 1, wherein the screen mesh is trapezoid shaped.

12. A method for making a heat pipe comprising the following steps:
providing a screen mesh, the screen mesh comprising a plurality of first wires and a plurality of second wires extending along different directions, a distance between the second wires being varied along the extending direction of the second wires;
rolling the screen mesh into a hollow column form;
positioning the rolled hollow column-shaped screen mesh into a pipe body of the heat pipe; and
filling a working fluid into the pipe body and sealing the pipe body.

13. The method of claim 12, wherein the distance between the second wires gradually decreases along the extending direction of the second wires.

14. The method of claim 12, wherein the screen mesh is constructed from stacking several meshes together.

15. The method of claim 12, wherein the screen mesh is rolled along an end-to-end direction of the screen mesh, the rolled screen mesh has a plurality of layers along a radial direction thereof, the layers having different average pore sizes, respectively.

16. The method of claim 12, wherein the screen mesh is rolled along a side-to-side direction of the screen mesh, the rolled screen mesh has a plurality of sections along a length thereof, the sections having different average pore sizes, respectively.

17. A method for forming a wick structure for a heat pipe, the wick structure able to generate capillary force for drawing condensed fluid in the heat pipe from a section to another section thereof, the method comprising:
preparing a flat screen mesh having two opposite ends and two opposite sides between the two opposite ends, the screen mesh having an average pore size varied along a length thereof; and
rolling the screen mesh into a hollow column shape.

18. The method of claim 17, wherein the screen mesh is rolled along an end-to-end direction of the screen mesh.

19. The method of the claim 17, wherein the screen mesh is rolled along a side-to-side direction of the screen mesh.

20. The method of claim 19, wherein the average pore size is varied continuously along the length of the screen mesh.
